(19) United States
(12) Patent Application Publication
(10) Pub. No.: US 2012/0059714 A1
(43) Pub. Date: Mar. 8, 2012

(54) Bundling User Lists with Ad Impressions

(75) Inventors: Vadim Furman, San Jose, CA (US); Rajas Moonka, San Ramon, CA (US); Anurag Agarwal, Sunnyvale, CA (US)

(73) Assignee: GOOGLE INC., Mountain View, CA (US)

(21) Appl. No.: 13/221,485

(22) Filed: Aug. 30, 2011

Related U.S. Application Data
(60) Provisional application No. 61/379,292, filed on Sep. 1, 2010.

(51) Int. Cl. G06Q 30/02

(52) U.S. Cl. 705/14.49; 705/14.69

(57) ABSTRACT

A computer-implemented method comprises identifying a user list where the user list includes a definition that characterizes members included in the user list, identifying available impressions that are satisfied by the definition, bundling the user list and the impressions into a bundle including determining a price to charge a consumer of the bundle, and providing the bundle to a consumer.

### CROSS-REFERENCE TO RELATED APPLICATION

This application claims priority to U.S. Provisional Application No. 61/379,292, filed on Sep. 1, 2010. The disclosure of the prior application is considered part of and is incorporated by reference in the disclosure of this application.

### TECHNICAL FIELD

This document relates to presenting content.

### BACKGROUND

Providing relevant advertising content to users is generally important to advertisers and service providers. However, implementing a cost-effective way of providing such relevant advertising content can prove difficult in an ever-changing online market. Further, while relevant information for targeting a particular user may be known by one entity, others may not readily have access to or be able to use such information when, for example, making targeting decisions.

### SUMMARY

This document discusses systems and techniques by which user lists are bundled with ad impressions.

In one aspect, a computer-implemented method comprises identifying a user list where the user list includes a definition that characterizes members included in the user list, identifying available impressions that are satisfied by the definition, bundling the user list and the impressions into a bundle including determining a price to charge a consumer of the bundle, and providing the bundle to a consumer.

Implementations can include any, all, or none of the following features. The consumer is an advertiser having a campaign that includes criteria that match the definition. A price further includes determining a price after acquiring the impressions and taking a subscription for a use of the user list for a given number of impressions. Providing the bundle to the consumer includes acquiring the impressions and taking a subscription for the consumer for a use of the user list for a given number of impressions. The user lists include data owned by a third party. The user lists are stored as a table indexed by a user identifier where each column defines a separate user list. The method further comprises generating the user list from owned or permissioned data of a third party. The method further comprises associating a user with a plurality of user lists from different data owners. Providing the bundle includes charging the consumer for the bundle based on the price and crediting the owner of the user list an amount appropriate for a number of impressions delivered. Bundling includes determining a subscription cost for a subscription to the user list for the number of available impressions and including the subscription cost in the price. Bundling includes determining a cost of allocation of the available impressions and including the allocation costs in the price.

In another aspect, a computer-implemented method comprises identifying an advertiser, the advertiser having a campaign including campaign targeting information and a campaign budget, where the campaign targeting information includes targeting criteria for ads and identifies one or more publisher sites of interest for providing impressions for hosting ads. The method include determining one or more user lists, the user lists including a definition that characterizes members in the lists, where identifying the user lists includes comparing the targeting criteria associated with the campaign with the user list definitions. The method includes determining available impressions at the one or more publisher sites. The method includes bundling the determined user lists and the determined available impressions into a bundle, including determining a price for the bundle. The method includes providing the bundle to a consumer including licensing the user list to the consumer for an available number of impressions and acquiring the determined available impressions.

In another aspect, a method comprises receiving from an advertiser a list of user lists that are of interest to the advertiser for use in targeting content to a user, receiving from an advertiser a list of websites that are of interest to the advertiser for serving impressions, determining available impressions associated with the list of websites, bundling one or more user lists from the list of user lists with the determined available impressions into a bundle where bundling includes pricing the bundle including pricing a subscription to the one or more user lists for a number of available impressions, and providing the bundle to the advertiser.

The details of one or more embodiments are set forth in the accompanying drawings and the description below. Other features and advantages will be apparent from the description and drawings, and from the claims.

### DESCRIPTION OF DRAWINGS

FIG. 1 is a schematic diagram of an example system for providing and using shared data.

FIG. 2 is a schematic diagram of example user lists.

FIG. 3 is a flow diagram of an example process for bundling a user list with ad impressions and providing the bundle to a consumer.

FIG. 4 is a flow diagram of an example process for soliciting an advertiser using a bundle of user lists and impressions.

FIG. 5 is a flow diagram of an example process for responding to an advertiser's request for a bundle of user lists and associated impressions.

FIG. 6 shows an example of a computer device and a mobile computer device that can be used to implement the techniques described here.

Like reference symbols in the various drawings indicate like elements.

### DETAILED DESCRIPTION

Advertisers, publishers, and service providers generally may wish to exchange data for purposes of implementing a meaningful way of providing information and/or services (e.g., advertising content) to online users. If specific content is determined to be meaningful to a particular user, then the user may wish to access the content, purchase the content, or otherwise interact with the content. This interaction can provide revenue to the content provider (e.g., advertiser, publisher or service provider). If a particular content provider (e.g., advertiser, publisher, or service provider) can collect data about how specific content may or may not be meaningful to users (i.e., in the form of a user list), the collected data may be used by others in a variety of ways. One use relates to selecting targeted content. Other uses are possible, such as in adjusting bids in an auction based, for example, on user lists that indicate specific content is of interest to one or more users. User lists can be published, sold, licensed or otherwise accessed to assist in providing personalized content to the specific users and increasing revenue for a content provider.

User lists can represent specific user information pertaining to predefined categories. The categories can be defined by the data owners. For example, a user list may include data about one or more users which characterizes the users to a category (e.g., homeowner, craftsman, DVD renter, etc.) to allow targeting of the users by, for example, publishers or advertisers. In some implementations, the user lists can be used to target relevant advertising content.

User lists can be generated and exchanged according to a number of rules, and those rules can be used to market particular user lists to specific consumers. The rules can employ methods of assigning users to particular user lists. Such rules can provide a logical categorization of data, information, or services for the purposes of determining which data content in the user lists is particularly relevant to a number of users.

Methods are described for associating user specific information with one or more user lists that are owned or maintained by a data owner. An association between the user-specific data and the user lists is made. The association can be exploited, for example, for real-time bidding in response to requests for content or to customize content to be provided to a specific user. Other uses of the user list information and associations are possible.

User lists can be bundled with advertisement (ad) impressions. Bundling includes offering user lists in combination with impressions that have been either reserved or otherwise made available to a bundling system. The acquisition of the impressions can occur either before the offer of the bundle to one or more consumers or after an offer has been accepted. Bundling allows subscribers to user lists to ensure that sufficient value is achieved from a given subscription. Subscribers to a user list can be assured that the subscription (e.g., where a subscription is for a specified number of impressions) is priced commensurate with use. For example, a subscriber that licenses a user list for use over 1000 impressions can be assured that the 1000 impressions will be won/available.

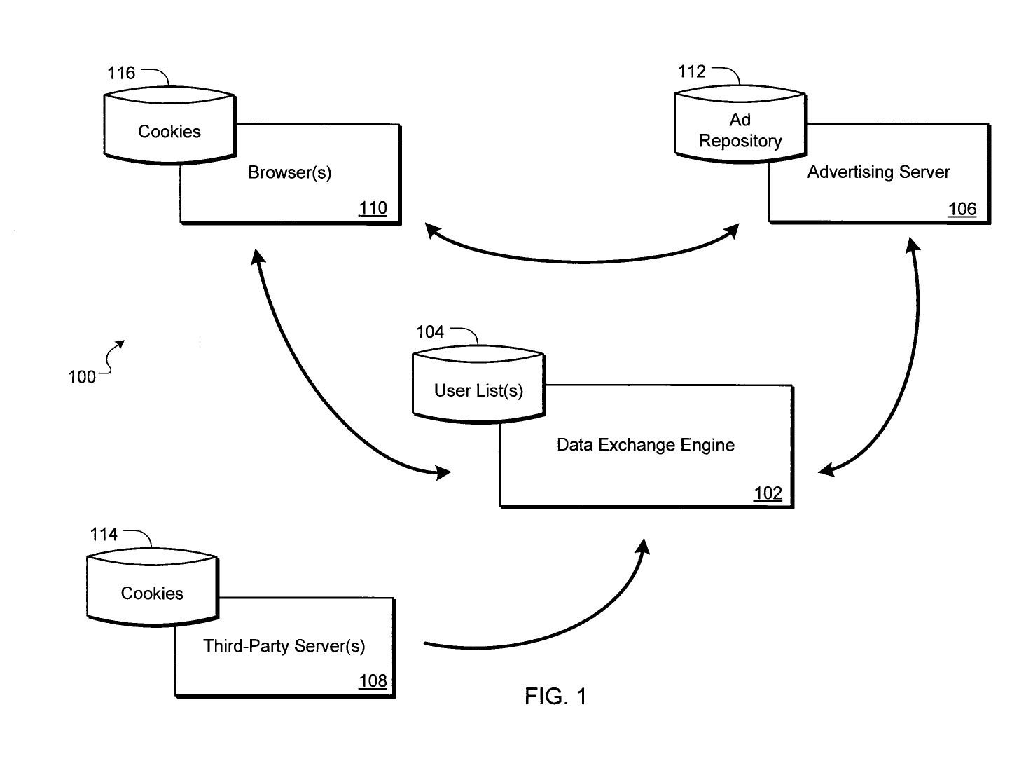

FIG. 1 is a schematic diagram of a system 100 for providing and using shared data. The shared data can, for example, include user lists detailing a number of predefined categories pertaining to specific users. The categories can be defined by or relate to user information including, but not limited to, browser history, user selections, cookie information, user-provided preferences, purchase histories, web search data, or other data (i.e., where the user has provided permission for the storing and/or collecting of such data). In some implementations, a user list is owned by a data provider that gathered the information in a respective user list. In some implementations, the user lists can be shared with other entities, such as for example using a data exchange. For example, the user lists can be shared amongst advertisers, third-party service providers, or third-party advertisers, data aggregators, and other online users.

The user lists can be provided to the data exchange and maintained by the data exchange and/or by the data owners. User lists can be updated as appropriate to either refine the category/categories associated therewith or the users that are members of a given list. Management of user lists is described in greater detail below.

The system 100 includes a data exchange engine 102 for providing an interface for advertisers and other consumers to discover and/or license user lists 104. The data exchange engine 102 can be configurable to maintain, update, present, license, sell or otherwise manage one or more user lists based on owned or permissioned data. The generated user lists can include user-specific associations characterizing specific online user behavior. The associations can be used, for example, to provide personalized content from an advertising server 106, a third-party server 108, or other content provider. The data exchange engine 102 as described here may parallel the functionality of an online advertisement exchange system for active targeted online advertisers, for example.

In some implementations, the data exchange engine 102 can create an exchange between owners of permissioned data and consumers of such data. Consumers of the permissioned data can include advertisers that seek to target particular categories of users. In some implementations, the data exchange engine 102 provides a mechanism for a provider of advertising placement services in targeted online advertising to make available additional third-party data sources to buyers of advertising space. In some implementations, the data exchange engine 102 can provide user lists to publishers, syndicates, and other data providers for various purposes, including the targeting of advertising content to users.

The data exchange engine 102 can provide an interface for data owners to securely view and manage their own data (i.e., manage a user list). For example, a data owner can generate and store information in a user list by entering data both manually and automatically. Other entities may be permitted to enter/maintain information in a user list. Publishers can also extract data for direct sales models or other marketing plans. Although computer hardware is not depicted in the data exchange engine 102, processors, memory, and other processing components may be included.

The advertising server 106 can provide advertising content to any number of browsers 110 via the data exchange engine 102 or directly. In addition, the advertising server 106 can be configurable for receiving advertising content requests and providing advertising content to requesting users. In operation, the advertising server 106 can select advertisements targeted based on one or more criteria and in view of data that is included in one or more user lists. The advertising server 106 can also provide access to other storage elements, such as ad repositories, in the example shown as ad repository 112. The ad repository 112 can be used to store advertising content associated with particular keywords, bidding criteria, advertisers, and targeting criteria. Data storage elements may include any one or combination of methods for storing data, including without limitation, arrays, hash tables, lists, and pairs. The advertising server 106 can access other similar types of data storage devices, such as user lists 104, for example.

In some implementations, advertisers can work with data providers to purchase or license user lists for purposes of targeting certain categories (e.g., demographic categories, interest categories, preference categories). The user lists can be analyzed for quality and other considerations. The advertisers can use the user lists for determining targeting criteria or to modify current bids, for example. In one example use case, an advertiser can subscribe for a period of time to a user list. The user list itself may be defined as being associated with a certain category (e.g., Internet shoppers interested in buying a sports car) of users. Requests for advertisements can be received by the advertising system, and the data exchange can be used to determine for a given user to which user lists the user is subscribed. In a real-time bid example, the advertisers that have subscribed to the user lists may be presented with the request (and necessarily information that the users satisfy the category(ies) associated with the user list(s)), and then may adjust/submit bids in consideration of such information. This is just one example of a use for the user list data.

The third-party servers 108 can provide third-party services to any number of browsers 110 via the data exchange engine 102. For example, the third-party servers 108 can provide web services, advertising services, or external APIs (application programming interfaces) to connect to a third-party server. The third-party servers 108 can include, for example, one or more servers executing a search engine application program. In some implementations, the third-party servers 108 can include a related information server or an advertising server. Third-party servers 108 can track user activity using cookies 114.

The browser 110 represents a user browsing the Internet. The browser 110 can access any website available on a network belonging to a person, or any other type of entity such as a company, enterprise, etc. For example, in FIG. 1 browser 110 can access a service or website. The service or website can be hosted by the third-party server 108, or alternatively by another server associated with system 100. A user can employ the browser 110 to search the Internet for services, information, or merchandise. The browser 110 can track user activity using cookies 116.

In some implementations, the advertising server 106 includes one or more advertisement customizers (not shown) operable to customize advertising content according to one or more user lists. In particular, an advertisement customizer can customize the display criteria, language, or other content of an advertisement according to user list information. For example, if a particular user list includes user-entered searching pertaining to purchasing a vehicle, the advertising server 106 can use the user-entered searching information (e.g., a cookie stored from performing a web search in a browser) to customize the display or content of an advertisement. The customization can, for example, provide the user with a more relevant advertisement.

In operation and for each generated user list, the system 100 can store, for example in a table-based repository, a list of user lists for which a particular user belongs. The table-based repository can, for example, be represented by a proprietary distributed storage system having a multi-dimensional sorted map as described in the paper entitled “Bigtable: A Distributed Storage System for Structured Data” by Fay Chang, Jeffrey Dean, Sanjay Ghemawat, Wilson C. Hsieh, Deborah A. Wallach, Mike Burrows, Tushar Chandra, Andrew Fikes, and Robert E. Gruber, the content of which is incorporated herein by reference in its entirety. The table-based repository represents a distributed storage system for managing structured data that is designed to scale to a very large size (e.g., petabytes of data across thousands of commodity servers). Each user list in the proprietary database can be included in one or more tables having multiple dimensions (one of which may be a field for time, allowing for versioning and garbage collection).

The system 100 can provide an index to the table-based repository. The index can be represented by a user cookie. For example, the table-based repository may be a set of rows and columns where the rows represent cookies corresponding to particular users and the columns represent a characterization associated with the user list, such as particular categories, keywords, websites, or other descriptive data.

At some point, the user browser 110 can make a request for advertising content from the advertising server 106 or the third-party server 108. The data exchange engine 102 can retrieve a list of user lists from the table-based repository associated with a received request and append or otherwise associate the list of user lists to/with the request. Any subsequent processing of the request can use the list, for example, for targeting, advertising customization and bid generation. The list of user lists or portions of the list can also be transmitted to a real-time bidder to provide the bidder with pertinent information about one or more users. Other uses are possible.

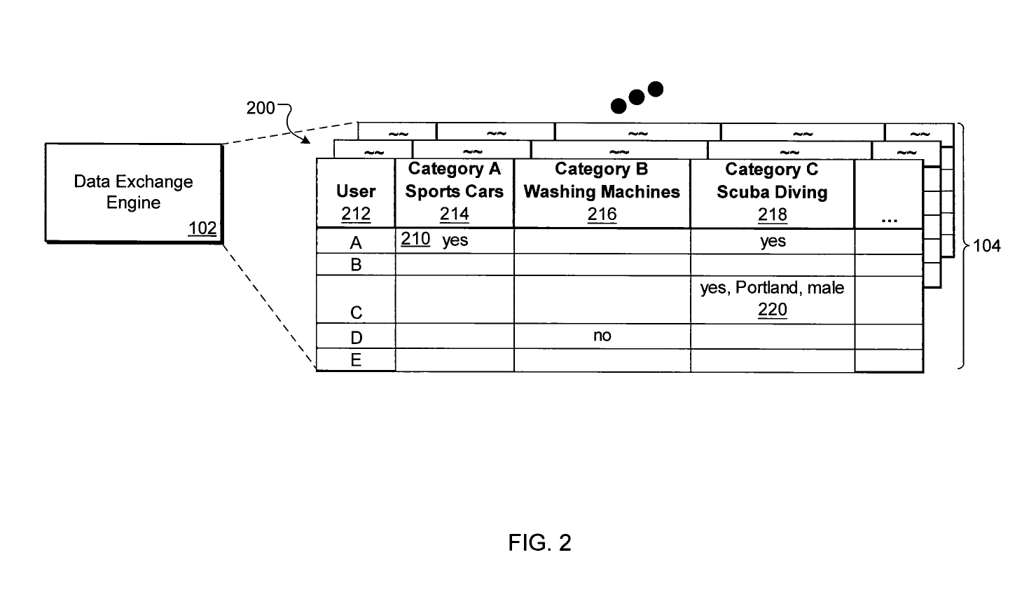

FIG. 2 is a schematic diagram of user lists 104 stored in a table 200. In this example, one or more entities (e.g., a web publishing entity that collected the user data) provided the user lists 104 to the data exchange engine 102. In some implementations, the user lists 104 in the table 200 are all provided by a same entity. Alternatively, the user lists 104 in the table 200 can include user lists owned/associated with different entities. In some implementations, users create their own user lists and provide the lists to the data exchange engine 102. For example, users can format content in user lists according to personal preferences and offer the user list data to the data exchange engine 102 for publication, management and use in targeting content to users. The data in the user lists 104 is developed, for example based at least in part on user-provided, searching and browser data. In this example, the data exchange engine 102 can manage the user lists 104 which details users 212 A-E. In some implementations, the table 200 can be indexed by a user identifier, such as the users 212 column.

Each row represents a single user. A user identifier (not shown) can be used to identify a user. The user identifier can be a user identifier associated with a user in a domain associated with the entity that owns/provides the data (i.e., a local identifier). In some implementations, such as those where plural different entities provide user lists that are stored in a single table, the user identifier can be of the form of a global identifier associated with the user, such as an identifier that the advertising system assigns to the user. Global identifiers can be associated with “local” entity identifiers and mapped such that requests that include a local entity identifier can be associated with the global identifier and hence, can be associated with user lists associated with plural entities. As a user can be associated with multiple user lists owned by different data owners, global identifiers can help to tie together those user lists for that user.

Each column represents a user list that includes a characterization (sometimes referred to as a definition), such as by way of a particular category(ies), keyword(s), website(s), demographic(s), interest(s), or other user classification. Example characterizations in the table 200 include sports cars, washing machines, and scuba diving. The characterization can include descriptors, such as keywords, that describe a given category. Each characterization may embody the combination of plural separate categories or subject matter. For example, the characterization sports cars, may embody those individuals that visited a web site that were interested in cars and those that were particularly interested in sports cars (which themselves represent two different categories). In some implementations, logical combinations of categories or subject matter can be used to define the characterization for a given user list.

Columns 214-218 of the table 200 each can identify, at least at a high level, a different characterization associated with a different user list. For example, the column 214 identifies users characterized by “Category A Sports Cars.” Other example characterizations and associated user lists are represented by column 216 (i.e., “Category B Washing Machines”) and column 218 (i.e., “Category C Scuba Diving”) to name a few examples. The table 200 can represent hundreds or thousands of characterizations and associated user lists.

In some implementations, each entry in the table 200 (i.e., the intersection of a row and a column) represents whether the user is a member of a given user list. For example, entry 210 indicates that user A is interested in or associated with a user list that has the characterization of sports cars. In some implementations, other data may be included in the entry. Other data can include geo-location data, cookie data, further personal data related to the user and known by the data owner, example web pages or example content (e.g., content surfed by the user), keyword searches, location data, website data, side vertical data, page vertical data, formatted text strings (where the data owner may include data related to the particular user in accordance with a definition set by the data owner (e.g., a series of bits that are set or not depending on the individual user's data for things like demographics, other interests, or other data that is different from the characterization but may be of use in targeting information to the particular user)) or other data. For example, entry 220 includes an indication that user C is not only a member of the user list associated with category C (scuba diving) but also that the user is located at a particular location (e.g., lives in Portland) and is a member of certain demographic groups (e.g., is male).

Identification of user lists to which a person belongs can be made by the data exchange engine 102 when a cookie or other user identifiable information is received. The data exchange engine 102 uses the cookie or user identifying information as an index to the user lists 104. For example, the data exchange engine 102 can cross reference received user identifier data with particular user list information to determine an association between user list data and the cookie data/user information. As shown in user lists 104, a user (A) showed an interest in user list A which is characterized by the keywords “sports cars”. For example, the user may, as part of a session with a given data provider, have provided a request to view sports cars made by Lexus such as providing a keyword search for “Lexus sports cars.”

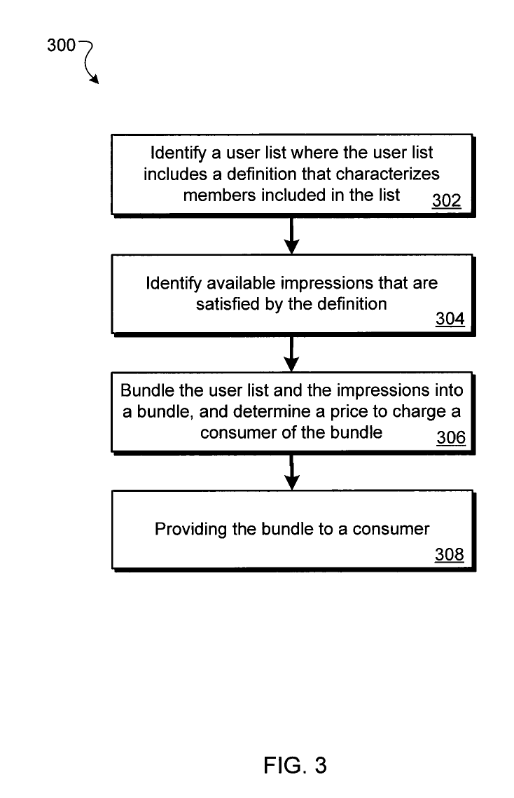

FIG. 3 is a flow diagram of an example process 300 for bundling a user list with ad impressions and providing the bundle to a consumer. The process 300 may be executed, for example, by the data exchange engine 102 shown in FIG. 1. More or fewer participants may be involved.

At stage 302, a user list is identified, and the user list includes a definition that characterizes members included in the list. The data exchange engine 102 can, for example, identify one of the user lists 104 that are stored in the table 200. For example, the data exchange engine 102 may identify the user list represented by column 218 (i.e., “Category C Scuba Diving”), and in this case, the definition can be “users who have used “scuba” as a search query keyword and/or viewed corresponding webpages, plus users who have clicked on scuba-related ads.” In some implementations, the user lists identified at this stage include data (e.g., user list information) owned by a third party.

At stage 304, available impressions that are satisfied by the definition are identified. As an example, the available impressions can include candidate slots on publishers' webpages that can potentially host ads that are available from any advertiser system, such as the ad server 106. The impressions identified in this stage are available impressions for ads that are likely to be of interest to users included in the user list identified at stage 302, e.g., the “Category C Scuba Diving” user list represented by column 218. The impressions identified at this stage can be, for example, several ad impressions related to scuba, such as scuba equipment, scuba lessons, scuba vacations, or scuba books, to name a few examples.

In stage 306, the user list and the impressions are bundled, and a price to charge a consumer of the bundle is determined. The user list that is bundled at this stage includes identifiers of the users associated with (or members of) the user list and the definition of the user list (e.g., “Scuba Diving” or “users who have searched on “scuba” or clicked on scuba-related ads.”). The data exchange engine 102 can identify the specific members of the user list by using the table 200 to find users having non-blank entries in column 218 (i.e., “Category C Scuba Diving”). In some implementations, the data exchange engine 102 can obtain the user identifiers from the users 212 column. In some implementations, the table 200 can store a local identifier (e.g., in the users 212 column) that is associated with a user in a particular entity domain that is mapped to a global identifier. The global identifier for a given user can be determined as part of the importing process described above with reference to FIG. 1. For example, the data exchange engine 102 can associate a global user identifier with a particular user that is included in a user list. In the current example, users A and C are associated with Category C Scuba Diving. The corresponding global user identifiers (e.g., corresponding to users A and C), though not shown in FIG. 2, can be included with the user list that is bundled with the ad impressions.

In addition to bundling the user identifier for each user who is a member of the user list, the data exchange engine 102 also includes other information that is pertinent to that user's membership. For example, entry 220 includes not only an indication that user C is a member Category C (scuba diving), but also the user's location (e.g., the user lives in Portland) and demographic information (e.g., the user is male). Other data stored in table 200 and described above can also be included, such as the user's relative income, age, education level, marital status, and so on.

This stage also determines a price for the bundle that is to be charged to the consumer. The consumer, for example, can be an advertiser who has an ad campaign that includes criteria matching the definition of the user list. In the current example, the data exchange engine 102 can determine the price to be charged to the advertiser based on several pricing factors, including the number of ad impressions included in the bundle, the number of users associated with the user list, the budget available to the advertiser, and so on. The resulting price is included with the bundle that is provided to the consumer (e.g., the advertiser).

In some implementations, the price determined at this stage includes determining the price after acquiring the impressions and taking a subscription for the use of the user list for a given number of impressions. For example, the data exchange engine 102 can wait to determine a price until after the consumer (e.g., an advertiser) has subscribed to the user list. In some implementations, pre-determined pricing schedules and/or guidelines can be used so that the consumer can generally have a rough idea of what the price may be. The pre-determined schedules and/or guidelines can be based on the number of impressions and the number of users in the user list, among other variables.

In some implementations, bundling at this stage includes determining a subscription cost for a subscription to the user list for the number of available impressions and including the subscription cost in the price. For example, the data exchange engine 102 can include with the bundle provided to the advertiser a subscription cost. The cost can be based on the number of available impressions on publishers' webpages that can potentially host ads from any advertiser system, such as the ad server 106.

In some implementations, bundling includes determining a cost of allocation of the available impressions and including the allocation costs in the price. For example, the data exchange engine 102 can include in its price (to the advertiser) the cost of allocating the available impressions.

At stage 308, the bundle is provided to a consumer. The data exchange engine 102 can, for example, provide the bundle to an advertiser (e.g., the advertiser who serves ads related to scuba diving). Upon receipt of the bundle, the advertiser may review the available impressions and the user list information, including the user identifiers for users who are members of the user list. The advertiser may also review the price of the bundle and decide whether or not to subscribe to the user list.

In some implementations, providing the bundle to the consumer (e.g., an advertiser) includes acquiring the impressions and taking a subscription for the consumer for the use of the user list for a given number of impressions. For example, the subscription can be based on the number of impressions that the advertiser expects to use.

In some implementations, providing the bundle includes charging the consumer (e.g., the advertiser) for the bundle based on the price and later crediting the owner of the user list an amount appropriate for a number of impressions delivered. Charging the consumer for a bundle is described above. In addition, a contract or other arrangement, for example, may exist between the entity that operates the data exchange engine 102 and the owner(s) of certain information in the user list(s). As an example, the owner of a user list may wish to receive monetary gain for each impression that results from the owned user list. Thus, as each impression is filled (and the advertiser's ad impression is served, e.g., in a user's browser), the data exchange engine 102 can credit the account of the particular user list's owner at the pre-determined amount, which may be based on the number of impressions.

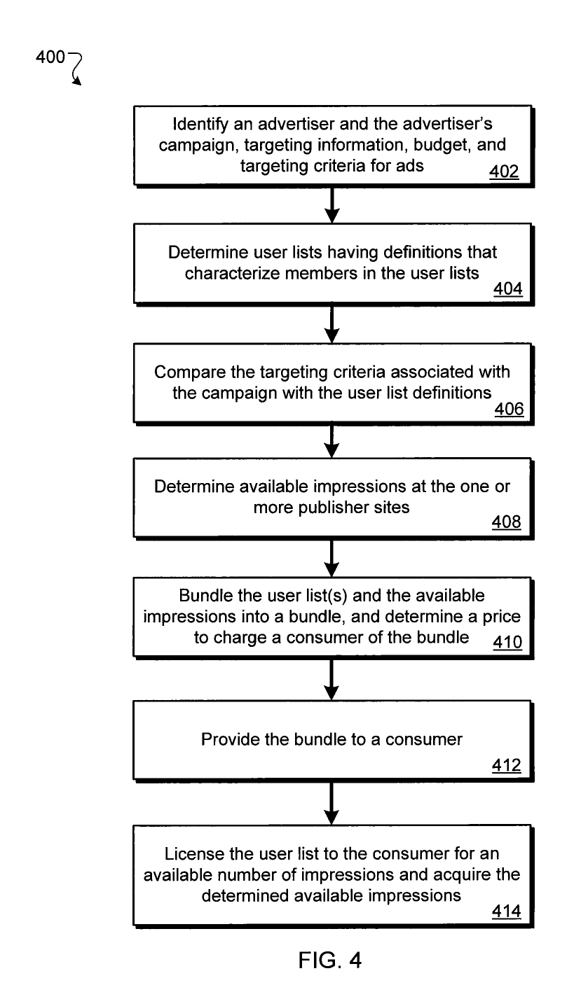

FIG. 4 is a flow diagram of an example process 400 for soliciting an advertiser using a bundle of user lists and impressions. The process 400 can be executed by, for example, the data exchange engine 102. More or fewer participants may be involved.

At stage 402, an advertiser is identified. The identified advertiser has a campaign including campaign targeting information and a campaign budget. The campaign targeting information includes targeting criteria for ads and identifies one or more publisher sites of interest for providing impressions for hosting ads. The data exchange engine 102 can, for example, identify XYZ Scuba Company as the advertiser. XYZ Scuba may have an existing ad campaign that is targeted to scuba enthusiasts who may want to buy a product from a new line of scuba equipment, and the budget for the ad campaign may be $3,000. The targeting criteria may include a list of several publisher sites (e.g., GreatDivingNews.com, etc., WaterSportsIsUs.com, etc.), each of which may be a prime website for serving scuba-related ads. In some implementations, the targeting criteria may include some representations regarding the intent of the advertiser (e.g., “we'd like to target these ads to several hundred scuba enthusiasts who may be interested in buying this new line of scuba equipment.”) The information identified here can, for example, set the stage for realizing the usefulness of user lists that may be bundled with ad impressions associated with the advertiser's ad campaign.

At stage 404, one or more user lists having definitions that characterize members in the user lists are determined. For example, the data exchange engine 102 can access the user lists 104 from the tables 200. Each of the user lists can have a definition, such as a definition related to sports cars, washing machines, scuba diving, and so on. In some implementations, each characterized user list can correspond to one or more columns (e.g., columns 214-218) in table 200.

At stage 406, the targeting criteria associated with the campaign are compared with the user list definitions. For example, the data exchange engine 102 can look at the “scuba enthusiasts” part of the advertiser's targeting criteria and search its repository of user lists (e.g., columns of table 200) for matching characterizing definitions of user lists. At this time, the data exchange engine 102 can determine that the scuba-related user list represented by column 218 is a “match” to the advertiser's targeting criteria. While the number of users shown as members of the “Category C Scuba Diving” user list is just two members (i.e., members A and C), several other users not shown in table 200 can exist.

In some implementations, the advertiser's targeting criteria may include other factors, such as location-based criteria, and as such, the targeting criteria may include a caveat such as “and we'd like to target our ads primarily to potential customers in the Pacific Northwest” (e.g., perhaps the only area that sells that particular line of scuba gear products). In this case, when comparing the campaign's targeting criteria with the user list definitions, the data exchange engine 102 can also access other information for each user. As a result, user C, who lives in Portland, may be included, while other users who are known to live far away from the Pacific Northwest (e.g., in the Midwest) may be left off the user list.

Example targeting criteria can include bounding boxes of geographical areas (e.g., including the Pacific Northwest), demographic information, client device information (e.g., “only serve these ads to users of mobile devices”), and so on.

In some implementations, multiple user lists can be determined at this stage. The data exchange engine 102 can, for example, locate a particular user list or build a custom user list (e.g., a user list of scuba diving enthusiasts, and a second user list of scuba diving enthusiasts in the Pacific Northwest). The data exchange engine 102 can further score, or in some other way annotate, the user lists so that the ultimate consumer of the user lists can decide how to use the information.

At stage 408, available impressions at the one or more publisher sites are obtained. The available ad impressions obtained can be the ad impressions associated with the one or more publisher sites of interest (e.g., GreatDivingNews.com, etc., WaterSportsIsUs.com, etc.) identified at stage 402. As an example, the data exchange engine 102 can determine available ad impression slots in the publishers' webpages for which an advertiser's ads from the advertising server 106 may apply. The available impressions may be considered more suitable available impressions (and thus more attractive to advertisers) because of matching processes that the data exchange engine 102 performs using user lists and targeting criteria.

At stage 410, the user lists and the available impressions are bundled. In some implementations, the user lists that are bundled at this stage include identifiers of the users associated with (or members of) each corresponding user list and the definition of each user list (e.g., “Scuba Diving” or “users who have searched on ‘scuba’ or clicked on scuba-related ads.”).

In addition to bundling the user identifier for each user who is a member of a particular user list, the data exchange engine 102 can also include other information that is pertinent to that user's membership. For example, entry 220 includes not only an indication that user C is a member Category C (scuba diving), but also the user's location (e.g., the user lives in Portland) and demographic information (e.g., the user is male). Other data stored in table 200 and described above can also be included, such as the user's relative income, age, education level, marital status, and so on. This type of additional information can be included with each of the user lists that are bundled at stage 410.

Stage 420 can also include determining a price for each user list in the bundle that is to be charged to the consumer. The consumer, for example, can be an advertiser who has an ad campaign that includes criteria that match the definition of the user list. In the current example, the data exchange engine 102 can determine the price to be charged to the advertiser based on several pricing factors, including the number of ad impressions included for each user list in the bundle, the number of users associated with the user list, the budget available to the advertiser, and so on. The resulting prices are included with the bundle that is provided to the consumer (e.g., the advertiser).

At stage 412, the bundle is provided/offered to a consumer. The data exchange engine 102 can, for example, provide the bundle to an advertiser (e.g., the advertiser who serves ads related to scuba diving).

At stage 414, the user lists are licensed/sold or otherwise transferred (herein after referred to in this specification as “licensed”) to the consumer for an available number of impressions. In some implementations, the licensing also includes the acquisition of the determined available impressions. The licensing can occur for the entire bundle, or for one or more individual user lists in the bundle. Upon receipt of the bundle (stage 412) and license terms, the advertiser may, for each of the user lists, review the available impressions and the user list information, including the user identifiers for users who are members of the user list. The advertiser may also review the price of each user list in the bundle and decide whether or not to subscribe to one or more of the user lists.

Stages 406-414 can be repeated for each of the advertiser's ad campaigns, each of which can have campaign targeting information and a campaign budget, where the campaign targeting information includes targeting criteria for ads and identifies one or more publisher sites of interest for providing impressions for hosting ads.

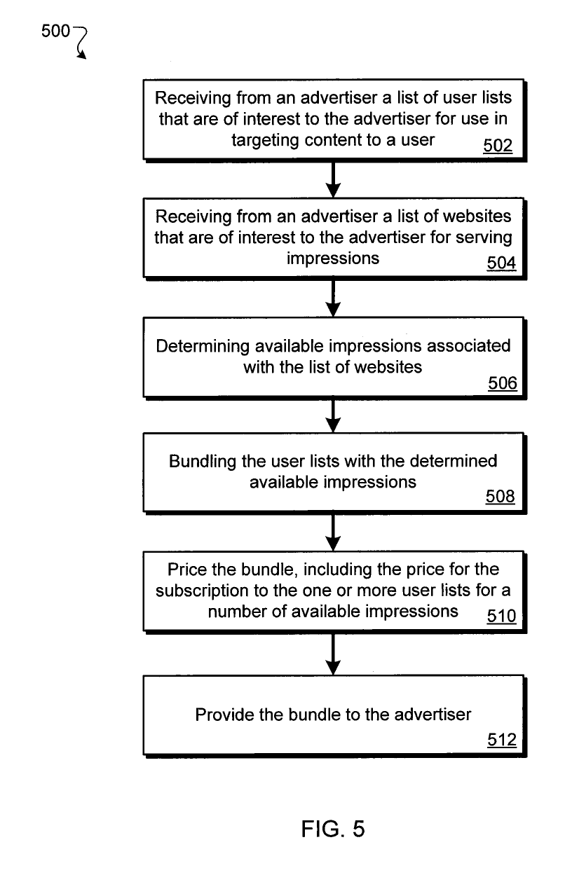

FIG. 5 is a flow diagram of an example process 500 for responding to an advertiser's request for a bundle of user lists and associated impressions. The process 500 can be executed by, for example, the data exchange engine 102. More or fewer participants may be involved.

At stage 502, a list of user lists is received from an advertiser that identifies user lists that are of interest to the advertiser for use in targeting content to a user. As an example, an advertiser may want to target ads to users who are members of particular user lists because the advertiser has products or services of potential interest to members of those user lists. The advertiser can, for example, provide the list of user lists to the data exchange engine 102. The list of user lists, in this case, can be simply the names or descriptions of the user lists, and not identify the user members of the user lists in any way. Example user lists that the advertiser can identify at this stage include “Category C Scuba Diving,” “scuba diving enthusiasts,” “users who visit scuba websites,” etc. In some implementations, the user lists that the advertiser provides in this stage can be the user lists to which the advertiser subscribes.

In some implementations, user lists can have associated identifiers, such as global user list identifiers, which may be numeric, for example. Thus, advertisers, when requesting a particular user list, can use a user list identifier (e.g., 1437) instead of some lengthy descriptive text (e.g., “users who visit scuba websites”). In some implementations, when an advertiser wishes to request a user list for which no user list identifier is known, the advertiser can provide keywords or other criteria by which the data exchange engine 102, for example, can locate one or more user lists.

At stage 504, a list of websites is received from an advertiser that identifies a list of websites that are of interest to the advertiser for serving impressions. For example, in addition to the types of users that an advertiser may want to target, the advertiser may want to specify certain websites for which to target the users. The websites, for example, may be websites that are known to be visited often by the targeted users, or the websites may be websites upon which the advertiser has in the past served impressions. The advertiser may select the specific websites in this case based on past conversion rates by users who have clicked on the advertiser's ads on those websites. The advertiser can, for example, provide the list of websites to the data exchange engine 102. Example websites received from the advertiser include one or more publisher sites of interest (e.g., GreatDivingNews.com, etc., WaterSportsIsUs.com, etc.).

At stage 506, available impressions associated with the list of websites are determined. In some implementations, the available impressions can be the ad impressions associated with the one or more publisher sites of interest (e.g., GreatDivingNews.com, etc., WaterSportsIsUs.com, etc.) identified at stage 504. As an example, the data exchange engine 102 can determine available ad impression slots in the publishers' webpages for which an advertiser's ads from the advertising server 106 may apply. The available impressions may be considered as more suitable available impressions (and thus more attractive to advertisers) because of matching processes that the data exchange engine 102 performs using user lists (and targeting criteria, if the advertiser includes that with request).

At stage 508, the user lists are bundled with the determined available impressions. In some implementations, the user lists that are bundled at this stage include identifiers of the users associated with (or members of) the corresponding user list and the definition of the user list (e.g., “Scuba Diving” or “users who have searched on “scuba” or clicked on scuba-related ads.”). The data exchange engine 102 can include any type of user identifiers, as described above for stage 306 of the process 300. The user identifiers can be included in the bundle that is created in this stage, so as to allow for the ready identification of the user list(s) that is (are) of interest. When bundling the user list information, the data exchange engine 102 can also include other information available for each user including, for example, the user's location (e.g., Portland), demographic information (e.g., male, relative income, age, education level, marital status, etc.), and so on. With this type of information, the advertiser can more effectively target the served ad impressions to individual (and groups of) users.

At stage 510, the bundle is priced, including the price for the subscription/purchase to the one or more user lists for a number of available impressions. In the current example, the data exchange engine 102 can determine the price to be charged to the advertiser based on several pricing factors, including the number of ad impressions included for each user list in the bundle, the number of users associated with the user lists, the budget available to the advertiser, and so on. The price includes the cost that the advertiser will pay for the subscription to the user lists, e.g., for the specified user lists and expected number of served ad impressions. The resulting prices are included with the bundle that is provided to the advertiser.

At stage 512, the bundle is provided to the advertiser. The data exchange engine 102 can, for example, provide the bundle to an advertiser who originally initiated the request by specifying a list of user lists (stage 502) and a list of websites (stage 504).

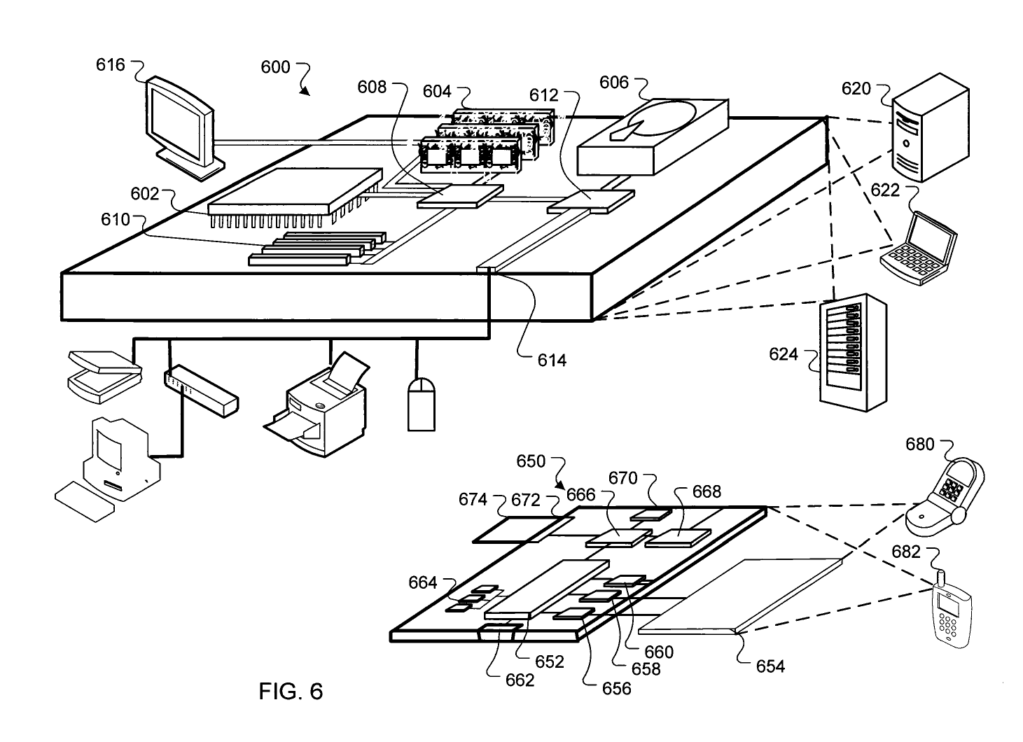

FIG. 6 shows an example of a generic computer device 600 and a generic mobile computer device 650 which may be used with the techniques described here. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652 that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. For example, much of this document has been described with respect to advertisements, but other forms of future, content delivery may also be supported.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method comprising:
identifying a user list where the user list includes a definition that characterizes members included in the user list;
identifying available impressions that are satisfied by the definition;
bundling the user list and the impressions into a bundle including determining a price to charge a consumer of the bundle; and
providing the bundle to a consumer.

2. The method of claim 1 where the consumer is an advertiser having a campaign that includes criteria that match the definition.

3. The method of claim 1 where determining a price further includes determining a price after acquiring the impressions and taking a subscription for a use of the user list for a given number of impressions.

4. The method of claim 1 where providing the bundle to the consumer includes acquiring the impressions and taking a subscription for the consumer for a use of the user list for a given number of impressions.

5. The method of claim 1 where the user lists include data owned by a third party.

6. The method of claim 1 where the user lists are stored as a table indexed by a user identifier where each column defines a separate user list.

7. The method of claim 1 further comprising generating the user list from owned or permissioned data of a third party.

8. The method of claim 1 further comprising associating a user with a plurality of user lists from different data owners.

9. The method of claim 1 where providing the bundle includes charging the consumer for the bundle based on the price and crediting the owner of the user list an amount appropriate for a number of impressions delivered.

10. The method of claim 1 where bundling includes determining a subscription cost for a subscription to the user list for the number of available impressions and including the subscription cost in the price.

11. The method of claim 10 where bundling includes determining a cost of allocation of the available impressions and including the allocation costs in the price.

12. A computer-implemented method comprising:
identifying an advertiser, the advertiser having a campaign including campaign targeting information and a campaign budget, where the campaign targeting information includes targeting criteria for ads and identifies one or more publisher sites of interest for providing impressions for hosting ads;
determining one or more user lists, the user lists including a definition that characterizes members in the lists, where identifying the user lists includes comparing the targeting criteria associated with the campaign with the user list definitions;
determining available impressions at the one or more publisher sites;
bundling the determined user lists and the determined available impressions into a bundle, including determining a price for the bundle; and
providing the bundle to a consumer including licensing the user list to the consumer for an available number of impressions and acquiring the determined available impressions.

13. A computer-implemented method comprising:
receiving from an advertiser a list of user lists that are of interest to the advertiser for use in targeting content to a user;
receiving from an advertiser a list of websites that are of interest to the advertiser for serving impressions;
determining available impressions associated with the list of websites;
bundling one or more user lists from the list of user lists with the determined available impressions into a bundle where bundling includes pricing the bundle including pricing a subscription to the one or more user lists for a number of available impressions; and
providing the bundle to the advertiser.
